(19) United States
(12) Patent Application Publication
(10) Pub. No.: US 2007/0255021 A1
(43) Pub. Date: Nov. 1, 2007

(54) Fluorinated Transition Metal Catalysts and Formation Thereof

(75) Inventors: Vladimir Marin, Houston, TX (US); Margarito Lopez, Pasadena, TX (US); Abbas Razavi, Mons (BE); Tim Coffy, Houston, TX (US)

Correspondence Address: FINA TECHNOLOGY INC, PO BOX 674412, HOUSTON, TX, 77267-4412, US

(73) Assignee: Fina Technology, Inc., Houston, TX (US)

(21) Appl. No.: 11/740,478

(22) Filed: Apr. 26, 2007

Related U.S. Application Data
(63) Continuation-in-part of application No. 11/413,791, filed on Apr. 28, 2006.

(51) Int. Cl. C08F 4/44; B01J 31/00

(52) U.S. Cl. 526/111; 502/162; 502/167

(57) ABSTRACT

Supported catalyst systems, methods of forming the supported catalyst systems and polymerization processes including the supported catalyst systems are described herein. The methods generally include providing an inorganic support composition, wherein the inorganic support composition comprises aluminum, fluorine and silica and contacting the inorganic support composition with a transition metal compound to form a supported catalyst system, wherein the transition metal compound is represented by the formula [L]ₘM[A]ₙ; wherein L is a bulky ligand, A is a leaving group, M is a transition metal and m and n are such that a total ligand valency corresponds to the transition metal valency. The methods further include contacting the inorganic support composition, the transition metal compound, the supported catalyst system or combinations thereof with at least one compound represented by the formula XRₙ, wherein X is selected from Group 12 to 13 metals, lanthanide series metals or combinations thereof and each R is independently selected from alkyls, alkoxys, aryls, aryloxys, halogens, hydrides, Group 1 or 2 metals, organic nitrogen compounds, organic phosphorous compounds and combinations thereof and n is from 2 to 5.

### CROSS-REFERENCE TO RELATED APPLICATIONS

This application claims the benefit of U.S. patent application Ser. No. 11/413,791, filed Apr. 28, 2006.

### FIELD

Embodiments of the present invention generally relate to supported catalyst compositions and methods of forming the same.

### BACKGROUND

Many methods of forming olefin polymers include contacting olefin monomers with transition metal catalyst systems, such as metallocene catalyst systems to form polyolefins. While it is widely recognized that the transition metal catalyst systems are capable of producing polymers having desirable properties, the transition metal catalysts generally do not experience commercially viable activities.

Therefore, a need exists to produce transition metal catalyst systems having enhanced activity.

### SUMMARY

Embodiments of the present invention include methods of forming supported catalyst systems and the catalyst systems formed therefrom. The methods generally include providing an inorganic support composition, wherein the inorganic support composition comprises aluminum, fluorine and silica and contacting the inorganic support composition with a transition metal compound to form a supported catalyst system, wherein the transition metal compound is represented by the formula [L]ₘM[A]ₙ; wherein L is a bulky ligand, A is a leaving group, M is a transition metal and m and n are such that a total ligand valency corresponds to the transition metal valency. The methods further include contacting the inorganic support composition, the transition metal compound, the supported catalyst system or combinations thereof with at least one compound represented by the formula XRₙ, wherein X is selected from Group 12 to 13 metals, lanthanide series metals or combinations thereof and each R is independently selected from alkyls, alkoxys, aryls, aryloxys, halogens, hydrides, Group 1 or 2 metals, organic nitrogen compounds, organic phosphorous compounds and combinations thereof and n is from 2 to 5.

In one specific embodiment, the method includes contacting the inorganic support composition, the transition metal compound, the supported catalyst system or combinations thereof with a plurality of compounds, wherein the plurality of compounds include a first compound including an organo aluminum compound and a second compound including boron.

Embodiments further include polymerization processes. Such processes generally include contacting the supported catalyst system with an olefin monomer to form a polyolefin.

### DETAILED DESCRIPTION

Introduction and Definitions

A detailed description will now be provided. Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims. Each of the inventions will now be described in greater detail below, including specific embodiments, versions and examples, but the inventions are not limited to these embodiments, versions or examples, which are included to enable a person having ordinary skill in the art to make and use the inventions when the information in this patent is combined with available information and technology.

Various terms as used herein are shown below. To the extent a term used in a claim is not defined below, it should be given the broadest definition persons in the pertinent art have given that term as reflected in printed publications and issued patents. Further, unless otherwise specified, all compounds described herein may be substituted or unsubstituted and the listing of compounds includes derivatives thereof.

As used herein, the terms “aluminum”, “silica”, “fluorine” and “boron” refer to the chemical composition, as well as derivates thereof, such as borates, for example.

As used herein, the term “ambient” is used interchangeable with “room temperature” and means that a temperature difference of a few degrees does not matter to the phenomenon under investigation, such as a preparation method. In some environments, room temperature may include a temperature of from about 20° C. to about 28° C. (68° F. to 82° F.), while in other environments, room temperature may include a temperature of from about 50° F. to about 90° F., for example. However, room temperature measurements generally do not include close monitoring of the temperature of the process and therefore such a recitation does not intend to bind the embodiments described herein to any predetermined temperature range.

As used herein, the term “fluorinated support” refers to a support that includes fluorine or fluoride molecules (e.g., incorporated therein or on the support surface.)

The term “activity” refers to the weight of product produced per weight of the catalyst used in a process per hour of reaction at a standard set of conditions (e.g., grams product/gram catalyst/hr).

The term “substituted” refers to an atom, radical or group replacing hydrogen in a chemical compound.

The term “tacticity” refers to the arrangement of pendant groups in a polymer. For example, a polymer is “atactic” when its pendant groups are arranged in a random fashion on both sides of the chain of the polymer. In contrast, a polymer is “isotactic” when all of its pendant groups are arranged on the same side of the chain and “syndiotactic” when its pendant groups alternate on opposite sides of the chain.

The term “bonding sequence” refers to an elements sequence, wherein each element is connected to another by sigma bonds, dative bonds, ionic bonds or combinations thereof.

Embodiments of the invention generally include supported catalyst compositions. The catalyst compositions generally include a support composition and a transition metal compound, which are described in greater detail below.

Such catalyst compositions generally are formed by contacting a support composition with a fluorinating agent to form a fluorinated support and contacting the fluorinated support with a transition metal compound to form a supported catalyst system. As discussed in further detail below, the catalyst systems may be formed in a number of ways and sequences.

Catalyst Systems

The support composition as used herein is an aluminum containing support material. For example, the support material may include an inorganic support composition. For example, the support material may include talc, inorganic oxides, clays and clay minerals, ion-exchanged layered compounds, diatomaceous earth compounds, zeolites or a resinous support material, such as a polyolefin, for example. Specific inorganic oxides include silica, alumina, magnesia, titania and zirconia, for example.

In one or more embodiments, the support composition is an aluminum containing silica support material. In one or more embodiments, the support composition is formed of spherical particles.

The aluminum containing silica support materials may have an average particle/pore size of from about 5 microns to 100 microns, or from about 15 microns to about 30 microns, or from about 10 microns to 100 microns or from about 10 microns to about 30 microns, a surface area of from 50 m²/g to 1,000 m²/g, or from about 80 m²/g to about 800 m²/g, or from 100 m²/g to 400 m²/g, or from about 200 m²/g to about 300 m²/g or from about 150 m²/g to about 300 m²/g and a pore volume of from about 0.1 cc/g to about 5 cc/g, or from about 0.5 cc/g to about 3.5 cc/g, or from about 0.5 cc/g to about 2.0 cc/g or from about 1.0 cc/g to about 1.5 cc/g, for example.

The aluminum containing silica support materials may further have an effective number or reactive hydroxyl groups, e.g., a number that is sufficient for binding the fluorinating agent to the support material. For example, the number of reactive hydroxyl groups may be in excess of the number needed to bind the fluorinating agent to the support material is minimized. For example, the support material may include from about 0.1 mmol OH⁻/g Si to about 5 mmol OH⁻/g Si, or from about 0.25 mmol OH⁻/g Si to about 4 mmol OH⁻/g Si or from from about 0.5 mmol OH⁻/g Si to about 3 mmol OH⁻/g Si.

The aluminum containing silica support materials are generally commercially available materials, such as P10 silica alumina that is commercially available from Fuji Sylisia Chemical LTD, for example (e.g., silica alumina having a surface area of 281 m²/g and a pore volume of 1.4 ml/g.)

The aluminum containing silica support materials may further have an aluminum content of from about 0.5 wt. % to about 95 wt %, or from about 0.1 wt. % to about 50 wt. %, or from about 2 wt. % to about 25 wt. %, or from about 0.1 wt. % to about 20 wt. %, or from about 10 wt. % to about 20 wt. % or from about 13 wt. % to about 17 wt. %, for example. The aluminum containing silica support materials may further have a silica to aluminum molar ratio of from about 0.01:1 to about 1000:1, or from about 0.1:1 to about 750:1 or from about 1:1 to about 500:1, for example.

Alternatively, the aluminum containing silica support materials may be formed by contacting a silica support material with a first aluminum containing compound. Such contact may occur at a reaction temperature of from about room temperature to about 150° C. The formation may further include calcining at a calcining temperature of from about 150° C. to about 600° C., or from about 200° C. to about 600° C. or from about 35° C. to about 500° C., for example. In one embodiment, the calcining occurs in the presence of an oxygen containing compound, for example.

In one or more embodiments, the support composition is prepared by a cogel method (e.g., a gel including both silica and alumina.) As used herein, the term “cogel method” refers to a preparation process including mixing a solution including the first aluminum containing compound into a gel of silica (e.g., Al₂(SO₄)+H₂SO₄+Na₂O—SiO₂.)

The first aluminum containing compound may include an organic aluminum containing compound. The organic aluminum containing compound may be represented by the formula AlR₃, wherein each R is independently selected from alkyls, aryls and combinations thereof. The organic aluminum compound may include methyl alumoxane (MAO) or modified methyl alumoxane (MMAO), for example or, in a specific embodiment, triethyl aluminum (TEAl) or triisobutyl aluminum (TIBAl), for example.

The support composition is fluorinated by methods known to one skilled in the art. For example, the support composition may be contacted with a fluorinating agent to form the fluorinated support. The fluorination process may include contacting the support composition with the fluorinating agent at a first temperature of from about 100° C. to about 200° C. for a first time of from about 1 hour to about 10 hours or from about 1 hour to about 5 hours, for example and then raising the temperature to a second temperature of from about 250° C. to about 550° C. or from about 400° C. to about 500° C. for a second time of from about 1 hour to about 10 hours, for example.

As described herein, the “support composition” may be impregnated with aluminum prior to contact with the fluorinating agent, after contact with the fluorinating agent or simultaneously as contact with the fluorinating agent. In one embodiment, the fluorinated support composition is formed by simultaneously forming SiO₂ and Al₂O₃ and then contacting the resulting compound with the fluorinating agent. In another embodiment, the fluorinated support composition is formed by contacting an aluminum containing silica support material with the fluorinating agent. In yet another embodiment, the fluorinated support composition is formed by contacting a silica support material with the fluorinating agent and then contacting the fluorinated support with the first aluminum containing compound.

The fluorinating agent generally includes any fluorinating agent which can form fluorinated supports. Suitable fluorinating agents include, but are not limited to, hydrofluoric acid (HF), ammonium fluoride (NH₄F), ammonium bifluoride (NH₄HF₂), ammonium fluoroborate (NH₄BF₄), ammonium silicofluoride ((NH₄)₂SiF₆), ammonium fluorophosphates (NH₄PF₆), (NH₄)₂TaF₇, NH₄NbF₄, (NH₄)₂GeF₆, (NH₄)₂SmF₆, (NH₄)₂TiF₆, (NH₆)ZrF₆, MoF₆, ReF₆, SO₂ClF, F₂, SiF₄, SF₆, ClF₃, ClF₅, BrF₅, IF₇, NF₃, HF, BF₃, NHF₂ and combinations thereof, for example. In one or more embodiments, the fluorinating agent is an ammonium fluoride including a metalloid or nonmetal (e.g., (NH₄)₂PF₆, (NH₄)₂BF₄, (NH₄)₂SiF₆).

In one or more embodiments, the molar ratio of fluorine to the first aluminum containing compound (F:Al¹) may be from about 0.5:1 to 6:1, or from about 2.5:1 to about 3.5:1 or from about 0.5:1 to about 4:1, for example.

In one or more embodiments, the fluorinated support may include from about 1 wt. % to about 30 wt. %, or from about 2 wt. % to about 15 wt. %, or from about 2 wt. % to about 10 wt. % or from about 5 wt. % to about 7 wt. % fluorine.

In one or more embodiments, the support composition has a bonding sequence selected from Si—O—Al—F, F—Si—O—Al or F—Si—O—Al—F, for example. In one or more embodiments, the aluminum and fluorine of the support composition are chemically bonded.

It has been observed that fluorinated supports having a high aluminum and fluorine content (as discussed previously) resulted in increased thermal stability, and therein increased activity.

Embodiments of the invention generally include contacting the fluorinated support with a transition metal compound to form a supported catalyst composition. Such processes are generally known to ones skilled in the art and may include charging the transition metal compound in an inert solvent. Although the process is discussed below in terms of charging the transition metal compound in an inert solvent, the fluorinated support (either in combination with the transition metal compound or alternatively) may be mixed with the inert solvent to form a support slurry prior to contact with the transition metal compound. Methods for supporting transition metal catalysts are generally known in the art. (See, U.S. Pat. No. 5,643,847, U.S. patent Ser. Nos. 09/184,358 and 09/184,389, which are incorporated by reference herein.)

A variety of non-polar hydrocarbons can be used as the inert solvent, but any non-polar hydrocarbon selected should remain in liquid form at all relevant reaction temperatures and the ingredients used to form the supported catalyst composition should be at least partially soluble in the non-polar hydrocarbon. Accordingly, the non-polar hydrocarbon is considered to be a solvent herein, even though in certain embodiments the ingredients are only partially soluble in the hydrocarbon.

Suitable hydrocarbons include substituted and unsubstituted aliphatic hydrocarbons and substituted and unsubstituted aromatic hydrocarbons. For example, the inert solvent may include hexane, heptane, octane, decane, toluene, xylene, dichloromethane, chloroform, 1-chlorobutane or combinations thereof.

The transition metal compound and the fluorinated support may be contacted at a reaction temperature of from about −60° C. to about 120° C. or from about −45° C. to about 112° C. or at a reaction temperature below about 90° C., e.g., from about 0° C. to about 50° C., or from about 20° C. to about 30° C. or at room temperature, for example, for a time of from about 10 minutes to about 5 hours or from about 30 minutes to about 120 minutes, for example.

In addition, and depending on the desired degree of substitution, the weight ratio of fluorine to transition metal (F:M) may be from about 1 equivalent to about 20 equivalents or from about 1 to about 5 equivalents, for example. In one embodiment, the supported catalyst composition includes from about 0.1 wt. % to about 5 wt. % transition metal compound.

Upon completion of the reaction, the solvent, along with reaction by-products, may be removed from the mixture in a conventional manner, such as by evaporation or filtering, to obtain the dry, supported catalyst composition. For example, the supported catalyst composition may be dried in the presence of magnesium sulfate. The filtrate, which contains the supported catalyst composition in high purity and yield can, without further processing, be directly used in the polymerization of olefins if the solvent is a hydrocarbon. In such a process, the fluorinated support and the transition metal compound are contacted prior to subsequent polymerization (e.g., prior to entering a reaction vessel.) Alternatively, the process may include contacting the fluorinated support with the transition metal in proximity to contact with an olefin monomer (e.g., contact within a reaction vessel.)

In one or more embodiments, the transition metal compound includes a metallocene catalyst, a late transition metal catalyst, a post metallocene catalyst or combinations thereof. Late transition metal catalysts may be characterized generally as transition metal catalysts including late transition metals, such as nickel, iron or palladium, for example. Post metallocene catalyst may be characterized generally as transition metal catalysts including Group 4, 5 or 6 metals, for example.

Metallocene catalysts may be characterized generally as coordination compounds incorporating one or more cyclopentadienyl (Cp) groups (which may be substituted or unsubstituted, each substitution being the same or different) coordinated with a transition metal through π bonding.

The substituent groups on Cp may be linear, branched or cyclic hydrocarbyl radicals, for example. The cyclic hydrocarbyl radicals may further form other contiguous ring structures, including indenyl, azulenyl and fluorenyl groups, for example. These contiguous ring structures may also be substituted or unsubstituted by hydrocarbyl radicals, such as C₁ to C₂₀ hydrocarbyl radicals, for example.

A specific, non-limiting, example of a metallocene catalyst is a bulky ligand metallocene compound generally represented by the formula:
[L]ₘM[A]ₙ;
wherein L is a bulky ligand, A is a leaving group, M is a transition metal and m and n are such that the total ligand valency corresponds to the transition metal valency. For example m may be from 1 to 3 and n may be from 1 to 3.

The metal atom “M” of the metallocene catalyst compound, as described throughout the specification and claims, may be selected from Groups 3 through 12 atoms and lanthanide Group atoms, or from Groups 3 through 10 atoms or from Sc, Ti, Zr, Hf, V, Nb, Ta, Mn, Re, Fe, Ru, Os, Co, Rh, Ir and Ni. The oxidation state of the metal atom “M” may range from 0 to +7 or is +1, +2, +3, +4 or +5, for example.

The bulky ligand generally includes a cyclopentadienyl group (Cp) or a derivative thereof. The Cp ligand(s) form at least one chemical bond with the metal atom M to form the “metallocene catalyst.” The Cp ligands are distinct from the leaving groups bound to the catalyst compound in that they are not highly susceptible to substitution/abstraction reactions.

Cp ligands may include ring(s) or ring system(s) including atoms selected from group 13 to 16 atoms, such as carbon, nitrogen, oxygen, silicon, sulfur, phosphorous, germanium, boron, aluminum and combinations thereof, wherein carbon makes up at least 50% of the ring members. Non-limiting examples of the ring or ring systems include cyclopentadienyl, cyclopentaphenanthreneyl, indenyl, benzindenyl, fluorenyl, tetrahydroindenyl, octahydrofluorenyl, cyclooctatetraenyl, cyclopentacyclododecene, phenanthrindenyl, 3,4-benzofluorenyl, 9-phenylfluorenyl, 8-H-cyclopent[a]acenaphthylenyl, 7-H-dibenzofluorenyl, indeno[1,2-9]anthrene, thiophenoindenyl, thiophenofluorenyl, hydrogenated versions thereof (e.g., 4,5,6,7-tetrahydroindenyl or “H₄Ind”), substituted versions thereof and heterocyclic versions thereof, for example.

Cp substituent groups may include hydrogen radicals, alkyls (e.g., methyl, ethyl, propyl, butyl, pentyl, hexyl, luoromethyl, fluroethyl, difluroethyl, iodopropyl, bromohexyl, benzyl, phenyl, methylphenyl, tert-butylphenyl, chlorobenzyl, dimethylphosphine and methylphenylphosphine), alkenyls (e.g., 3-butenyl, 2-propenyl and 5-hexenyl), alkynyls, cycloalkyls (e.g., cyclopentyl and cyclohexyl), aryls (e.g., trimethylsilyl, trimethylgermyl, methyldiethylsilyl, acyls, aroyls, tris(trifluoromethyl)silyl, methylbis(difluoromethyl)silyl and bromomethyldimethylgermyl), alkoxys (e.g., methoxy, ethoxy, propoxy and phenoxy), aryloxys, alkylthiols, dialkylamines (e.g., dimethylamine and diphenylamine), alkylamidos, alkoxycarbonyls, aryloxycarbonyls, carbomoyls, alkyl- and dialkyl-carbamoyls, acyloxys, acylaminos, aroylaminos, organometalloid radicals (e.g., dimethylboron), Group 15 and Group 16 radicals (e.g., methylsulfide and ethylsulfide) and combinations thereof, for example. In one embodiment, at least two substituent groups, two adjacent substituent groups in one embodiment, are joined to form a ring structure.

Each leaving group “A” is independently selected and may include any ionic leaving group, such as halogens (e.g., chloride and fluoride), hydrides, C₁ to C₁₂ alkyls (e.g., methyl, ethyl, propyl, phenyl, cyclobutyl, cyclohexyl, heptyl, tolyl, trifluoromethyl, methylphenyl, dimethylphenyl and trimethylphenyl), C₂ to C₁₂ alkenyls (e.g., C₂ to C₆ fluoroalkenyls), C₆ to C₁₂ aryls (e.g., C₇ to C₂₀ alkylaryls), C₁ to C₁₂ alkoxys (e.g., phenoxy, methyoxy, ethyoxy, propoxy and benzoxy), C₆ to C₁₆ aryloxys, C₇ to C₁₈ alkylaryloxys and C₁ to C₁₂ heteroatom-containing hydrocarbons and substituted derivatives thereof, for example.

Other non-limiting examples of leaving groups include amines, phosphines, ethers, carboxylates (e.g., C₁ to C₆ alkylcarboxylates, C₆ to C₁₂ arylcarboxylates and C₇ to C₁₈ alkylarylcarboxylates), dienes, alkenes (e.g., tetramethylene, pentamethylene, methylidene), hydrocarbon radicals having from 1 to 20 carbon atoms (e.g., pentafluorophenyl) and combinations thereof, for example. In one embodiment, two or more leaving groups form a part of a fused ring or ring system.

In a specific embodiment, L and A may be bridged to one another to form a bridged metallocene catalyst. A bridged metallocene catalyst, for example, may be described by the general formula:
XCp^{A}Cp^{B}MAₙ;
wherein X is a structural bridge, Cp^{A} and Cp^{B} each denote a cyclopentadienyl group, each being the same or different and which may be either substituted or unsubstituted, M is a transition metal and A is an alkyl, hydrocarbyl or halogen group and n is an integer between 0 and 4, and either 1 or 2 in a particular embodiment.

Non-limiting examples of bridging groups “X” include divalent hydrocarbon groups containing at least one Group 13 to 16 atom, such as, but not limited to, at least one of a carbon, oxygen, nitrogen, silicon, aluminum, boron, germanium, tin and combinations thereof, wherein the heteroatom may also be a C₁ to C₁₂ alkyl or aryl group substituted to satisfy a neutral valency. The bridging group may also contain substituent groups as defined above including halogen radicals and iron. More particular non-limiting examples of bridging group are represented by C₁ to C₆ alkylenes, substituted C₁ to C₆ alkylenes, oxygen, sulfur, R₂C═, R₂Si═, —Si(R)₂Si(R₂)—, R₂Ge═ or RP═ (wherein “═” represents two chemical bonds), where R is independently selected from hydrides, hydrocarbyls, halocarbyls, hydrocarbyl-substituted organometalloids, halocarbyl-substituted organometalloids, disubstituted boron atoms, disubstituted Group 15 atoms, substituted Group 16 atoms and halogen radicals, for example. In one embodiment, the bridged metallocene catalyst component has two or more bridging groups.

Other non-limiting examples of bridging groups include methylene, ethylene, ethylidene, propylidene, isopropylidene, diphenylmethylene, 1,2-dimethylethylene, 1,2-diphenylethylene, 1,1,2,2-tetramethylethylene, dimethylsilyl, diethylsilyl, methyl-ethylsilyl, trifluoromethylbutylsilyl, bis(trifluoromethyl)silyl, di(n-butyl)silyl, di(n-propyl)silyl, di(i-propyl)silyl, di(n-hexyl)silyl, dicyclohexylsilyl, diphenylsilyl, cyclohexylphenylsilyl, t-butylcyclohexylsilyl, di(t-butylphenyl)silyl, di(p-tolyl)silyl and the corresponding moieties, wherein the Si atom is replaced by a Ge or a C atom; dimethylsilyl, diethylsilyl, dimethylgermyl and/or diethylgermyl.

In another embodiment, the bridging group may also be cyclic and include 4 to 10 ring members or 5 to 7 ring members, for example. The ring members may be selected from the elements mentioned above and/or from one or more of boron, carbon, silicon, germanium, nitrogen and oxygen, for example. Non-limiting examples of ring structures which may be present as or part of the bridging moiety are cyclobutylidene, cyclopentylidene, cyclohexylidene, cycloheptylidene, cyclooctylidene, for example. The cyclic bridging groups may be saturated or unsaturated and/or carry one or more substituents and/or be fused to one or more other ring structures. The one or more Cp groups which the above cyclic bridging moieties may optionally be fused to may be saturated or unsaturated. Moreover, these ring structures may themselves be fused, such as, for example, in the case of a naphthyl group.

In one embodiment, the metallocene catalyst includes CpFlu Type catalysts (e.g., a metallocene catalyst wherein the ligand includes a Cp fluorenyl ligand structure) represented by the following formula:
X(CpR¹ₙR²ₘ)(FlR³ₚ);
wherein Cp is a cyclopentadienyl group, Fl is a fluorenyl group, X is a structural bridge between Cp and Fl, R¹ is a substituent on the Cp, n is 1 or 2, R² is a substituent on the Cp at a position which is ortho to the bridge, m is 1 or 2, each R³ is the same or different and is a hydrocarbyl group having from 1 to 20 carbon atoms with at least one R³ being substituted in the para position on the fluorenyl group and at least one other R³ being substituted at an opposed para position on the fluorenyl group and p is 2 or 4.

In yet another aspect, the metallocene catalyst includes bridged mono-ligand metallocene compounds (e.g., mono cyclopentadienyl catalyst components). In this embodiment, the metallocene catalyst is a bridged “half-sandwich” metallocene catalyst. In yet another aspect of the invention, the at least one metallocene catalyst component is an unbridged “half sandwich” metallocene. (See, U.S. Pat. No. 6,069,213, U.S. Pat. No. 5,026,798, U.S. Pat. No. 5,703,187, U.S. Pat. No. 5,747,406, U.S. Pat. No. 5,026,798 and U.S. Pat. No. 6,069,213, which are incorporated by reference herein.)

Non-limiting examples of metallocene catalyst components consistent with the description herein include, for example:
cyclopentadienylzirconiumAₙ,
indenylzirconiumAₙ,
(1-methylindenyl)zirconiumAₙ,
(2-methylindenyl)zirconiumAₙ,
(1-propylindenyl)zirconiumAₙ,
(2-propylindenyl)zirconiumAₙ,
(1-butylindenyl)zirconiumAₙ,
(2-butylindenyl)zirconiumAₙ,
methylcyclopentadienylzirconiumAₙ,
tetrahydroindenylzirconiumAₙ,
pentamethylcyclopentadienylzirconiumAₙ,
cyclopentadienylzirconiumAₙ,
pentamethylcyclopentadienyltitaniumAₙ,
tetramethylcyclopentyltitaniumAₙ,
(1,2,4-trimethylcyclopentadienyl)zirconiumAₙ,
dimethylsilyl(1,2,3,4-tetramethylcyclopentadienyl)(cyclopentadienyl)zirconiumAₙ,
dimethylsilyl(1,2,3,4-tetramethylcyclopentadienyl)(1,2,3-trimethylcyclopentadienyl)zirconiumAₙ,
dimethylsilyl(1,2,3,4-tetramethylcyclopentadienyl)(1,2-dimethylcyclopentadienyl)zirconiumAₙ,
dimethylsilyl(1,2,3,4-tetramethylcyclopentadienyl)(2-methylcyclopentadienyl)zirconiumAₙ,
dimethylsilylcyclopentadienylindenylzirconiumAₙ,
dimethylsilyl(2-methylindenyl)(fluorenyl)zirconiumAₙ,
diphenylsilyl(1,2,3,4-tetramethylcyclopentadienyl)(3-propylcyclopentadienyl)zirconiumAₙ,
dimethylsilyl(1,2,3,4-tetramethylcyclopentadienyl)(3-t-butylcyclopentadienyl)zirconiumAₙ,
dimethylgermyl(1,2-dimethylcyclopentadienyl)(3-isopropylcyclopentadienyl)zirconiumAₙ,
dimethylsilyl(1,2,3,4-tetramethylcyclopentadienyl)(3-methylcyclopentadienyl)zirconiumAₙ,
diphenylmethylidene(cyclopentadienyl)(9-fluorenyl)zirconiumAₙ,
diphenylmethylidenecyclopentadienylindenylzirconiumAₙ,
isopropylidenebiscyclopentadienylzirconiumAₙ,
isopropylidene(cyclopentadienyl)(9-fluorenyl)zirconiumAₙ,
isopropylidene(3-methylcyclopentadienyl)(9-fluorenyl)zirconiumAₙ,
ethylenebis(9-fluorenyl)zirconiumAₙ,
ethylenebis(1-indenyl)zirconiumAₙ,
ethylenebis(1-indenyl)zirconiumAₙ,
ethylenebis(2-methyl-1-indenyl)zirconiumAₙ,
ethylenebis(2-methyl-4,5,6,7-tetrahydro-1-indenyl)zirconiumAₙ,
ethylenebis(2-propyl-4,5,6,7-tetrahydro-1-indenyl)zirconiumAₙ,
ethylenebis(2-isopropyl-4,5,6,7-tetrahydro-1-indenyl)zirconiumAₙ,
ethylenebis(2-butyl-4,5,6,7-tetrahydro-1-indenyl)zirconiumAₙ,
ethylenebis(2-isobutyl-4,5,6,7-tetrahydro-1-indenyl)zirconiumAₙ,
dimethylsilyl(4,5,6,7-tetrahydro-1-indenyl)zirconiumAₙ,
diphenyl(4,5,6,7-tetrahydro-1-indenyl)zirconiumAₙ,
ethylenebis(4,5,6,7-tetrahydro-1-indenyl)zirconiumAₙ,
dimethylsilylbis(cyclopentadienyl)zirconiumAₙ,
dimethylsilylbis(9-fluorenyl)zirconiumAₙ,
dimethylsilylbis(1-indenyl)zirconiumAₙ,
dimethylsilylbis(2-methylindenyl)zirconiumAₙ,
dimethylsilylbis(2-propylindenyl)zirconiumAₙ,
dimethylsilylbis(2-butylindenyl)zirconiumAₙ,
diphenylsilylbis(2-methylindenyl)zirconiumAₙ,
diphenylsilylbis(2-propylindenyl)zirconiumAₙ,
diphenylsilylbis(2-butylindenyl)zirconiumAₙ,
dimethylgermylbis(2-methylindenyl)zirconiumAₙ,
dimethylsilylbistetrahydroindenylzirconiumAₙ,
dimethylsilylbistetramethylcyclopentadienylzirconiumAₙ, dimethylsilyl(cyclopentadienyl)(9-fluorenyl)zirconiumAₙ, diphenylsilyl(cyclopentadienyl)(9-fluorenyl)zirconiumAₙ,
diphenylsilylbisindenylzirconiumAₙ,
cyclotrimethylenesilyltetramethylcyclopentadienylcyclopentadienylzirconiumAₙ,
cyclotetramethylenesilyltetramethylcyclopentadienylcyclopentadienylzirconiumAₙ,
cyclotrimethylenesilyl(tetramethylcyclopentadienyl)(2-methylindenyl)zirconiumAₙ,
cyclotrimethylenesilyl(tetramethylcyclopentadienyl)(3-methylcyclopentadienyl)zirconiumAₙ,
cyclotrimethylenesilylbis(2-methylindenyl)zirconiumAₙ,
cyclotrimethylenesilyl(tetramethylcyclopentadienyl)(2,3,5-trimethylclopentadienyl)zirconiumAₙ,
cyclotrimethylenesilylbis(tetramethylcyclopentadienyl)zirconiumAₙ,
dimethylsilyl(tetramethylcyclopentadieneyl)(N-tertbutylamido)titaniumAₙ,
biscyclopentadienylchromiumAₙ,
biscyclopentadienylzirconiumAₙ,
bis(n-butylcyclopentadienyl)zirconiumAₙ,
bis(n-dodecyclcyclopentadienyl)zirconiumAₙ,
bisethylcyclopentadienylzirconiumAₙ,
bisisobutylcyclopentadienylzirconiumAₙ,
bisisopropylcyclopentadienylzirconiumAₙ,
bismethylcyclopentadienylzirconiumAₙ,
bisnoxtylcyclopentadienylzirconiumAₙ,
bis(n-pentylcyclopentadienyl)zirconiumAₙ,
bis(n-propylcyclopentadienyl)zirconiumAₙ, bistrimethylsilylcyclopentadienylzirconiumAₙ,
bis(1,3-bis(trimethylsilyl)cyclopentadienyl)zirconiumAₙ,
bis(1-ethyl-2-methylcyclopentadienyl)zirconiumAₙ,
bis(1-ethyl-3-methylcyclopentadienyl)zirconiumAₙ,
bispentamethylcyclopentadienylzirconiumAₙ, bispentamethylcyclopentadienylzirconiumAₙ,
bis(1-propyl-3-methylcyclopentadienyl)zirconiumAₙ,
bis(1-n-butyl-3-methylcyclopentadienyl)zirconiumAₙ,
bis(1-isobutyl-3-methylcyclopentadienyl)zirconiumAₙ,
bis(1-propyl-3-butylcyclopentadienyl)zirconiumAₙ,
bis(1,3-n-butylcyclopentadienyl)zirconiumAₙ,
bis(4,7-dimethylindenyl)zirconiumAₙ,
bisindenylzirconiumAₙ,
bis(2-methylindenyl)zirconiumAₙ,
cyclopentadienylindenylzirconiumAₙ,
bis(n-propylcyclopentadienyl)hafniumAₙ,
bis(n-butylcyclopentadienyl)hafniumAₙ,
bis(n-pentylcyclopentadienyl)hafniumAₙ,
(n-propylcyclopentadienyl)(n-butylcyclopentadienyl)hafniumAₙ,
bis[(2-trimethylsilylethyl)cyclopentadienyl]hafniumAₙ,
bis(trimethylsilylcyclopentadienyl)hafniumAₙ,
bis(2-n-propylindenyl)hafniumAₙ,
bis(2-n-butylindenyl)hafniumAₙ,
dimethylsilylbis(n-propylcyclopentadienyl)hafniumAₙ,
dimethylsilylbis(n-butylcyclopentadienyl)hafniumAₙ,
bis(9-n-propylfluorenyl)hafniumAₙ,
bis(9-n-butylfluorenyl)hafniumAₙ,
(9-n-propylfluorenyl)(2-n-propylindenyl)hafniumAₙ,
bis(1-n-propyl-2-methylcyclopentadienyl)hafniumAₙ,
(n-propylcyclopentadienyl)(1-n-propyl-3-n-butylcyclopentadienyl)hafniumAₙ,
dimethylsilyltetramethylcyclopentadienylcyclopropylamidotitaniumAₙ,
dimethylsilyltetramethyleyclopentadienylcyclobutylamidotitaniumAₙ,
dimethylsilyltetramethyleyclopentadienylcyclopentylamidotitaniumAₙ,
dimethylsilyltetramethylcyclopentadienylcyclohexylamidotitaniumAₙ,
dimethylsilyltetramethylcyclopentadienylcycloheptylamidotitaniumAₙ,
dimethylsilyltetramethylcyclopentadienylcyclooctylamidotitaniumAₙ,
dimethylsilyltetramethylcyclopentadienylcyclononylamidotitaniumAₙ,
dimethylsilyltetramethylcyclopentadienylcyclodecylamidotitaniumAₙ,
dimethylsilyltetramethylcyclopentadienylcycloundecylamidotitaniumAₙ,
dimethylsilyltetramethylcyclopentadienylcyclododecylamidotitaniumAₙ,
dimethylsilyltetramethylcyclopentadienyl(sec-butylamido)titaniumAₙ,
dimethylsilyl(tetramethylcyclopentadienyl)(n-octylamido)titaniumAₙ,
dimethylsilyl(tetramethylcyclopentadienyl)(n-decylamido)titaniumAₙ,
dimethylsilyl(tetramethylcyclopentadienyl)(n-octadecylamido)titaniumAₙ,
methylphenylsilyltetramethylcyclopentadienylcyclopropylamidotitaniumAₙ,
methylphenylsilyltetramethylcyclopentadienylcyclobutylamidotitaniumAₙ,
methylphenylsilyltetramethylcyclopentadienylcyclopentylamidotitaniumAₙ,
methylphenylsilyltetramethylcyclopentadienylcyclohexylamidotitaniumAₙ,
methylphenylsilyltetramethylcyclopentadienylcycloheptylamidotitaniumAₙ,
methylphenylsilyltetramethylcyclopentadienylcyclooctylamidotitaniumAₙ,
methylphenylsilyltetramethylcyclopentadienylcyclononylamidotitaniumAₙ,
methylphenylsilyltetramethylcyclopentadienylcyclodecylamidotitaniumAₙ,
methylphenylsilyltetramethylcyclopentadienylcycloundecylamidotitaniumAₙ,
methylphenylsilyltetramethylcyclopentadienylcyclododecylamidotitaniumAₙ,
methylphenylsilyl(tetramethylcyclopentadienyl)(sec-butylamido)titaniumAₙ,
methylphenylsilyl(tetramethylcyclopentadienyl)(n-octylamido)titaniumAₙ,
methylphenylsilyl(tetramethylcyclopentadienyl)(n-decylamido)titaniumAₙ,
methylphenylsilyl(tetramethylcyclopentadienyl)(n-octadecylamido)titaniumAₙ,
diphenylsilyltetramethylcyclopentadienylcyclopropylamidotitaniumAₙ,
diphenylsilyltetramethylcyclopentadienylcyclobutylamidotitaniumAₙ,
diphenylsilyltetramethylcyclopentadienylcyclopentylamidotitaniumAₙ,
diphenylsilyltetramethylcyclopentadienylcyclohexylamidotitaniumAₙ,
diphenylsilyltetramethylcyclopentadienylcycloheptylamidotitaniumAₙ,
diphenylsilyltetramethylcyclopentadienylcyclooctylamidotitaniumAₙ,
diphenylsilyltetramethylcyclopentadienylcyclononylamidotitaniumAₙ,
diphenylsilyltetramethylcyclopentadienylcyclodecylamidotitaniumAₙ,
diphenylsilyltetramethylcyclopentadienylcycloundecylamidotitaniumAₙ,
diphenylsilyltetramethylcyclopentadienylcyclododecylamidotitaniumAₙ,
diphenylsilyl(tetramethylcyclopentadienyl)(sec-butylamido)titaniumAₙ,
diphenylsilyl(tetramethylcyclopentadienyl)(n-octylamido)titaniumAₙ,
diphenylsilyl(tetramethylcyclopentadienyl)(n-decylamido)titaniumAₙ,
diphenylsilyl(tetramethylcyclopentadienyl)(n-octadecylamido)titaniumAₙ.

In one or more embodiments, the transition metal compound includes cyclopentadienyl ligands, indenyl ligands, fluorenyl ligands, tetrahydroindenyl ligands, alkyls, aryls, amides or combinations thereof In one or more embodiments, the transition metal compound includes a transition metal dichloride, dimethyl or hydride. In one or more embodiments, the transition metal compound may have C₁, Cₛ or C₂ symmetry, for example.

In one or more embodiments, L is selected from C₄ to C₃₀ hydrocarbons, oxygen, nitrogen, phosphorous and combinations thereof. In one or more embodiments, M is selected from Group 3 to Group 14 metals, lanthanides, actinides and combinations thereof. In one or more embodiments, A is selected from halogens, C₄ to C₃₀ hydrocarbons and combinations thereof. In one specific embodiment, the transition metal compound includes rac-dimethylsilanylbis(2-methyl-4-phenyl-1-indenyl)zirconium dichloride.

One or more embodiments may further include contacting the fluorinated support with a plurality of catalyst compounds (e.g., a bimetallic catalyst.) As used herein, the term “bimetallic catalyst” means any composition, mixture or system that includes at least two different catalyst compounds, each having a different metal group. Each catalyst compound may reside on a single support particle so that the bimetallic catalyst is a supported bimetallic catalyst. However, the term bimetallic catalyst also broadly includes a system or mixture in which one of the catalysts resides on one collection of support particles and another catalyst resides on another collection of support particles. The plurality of catalyst components may include any catalyst component known to one skilled in the art, so long as at least one of those catalyst components includes a transition metal compound as described herein.

As demonstrated in the examples that follow, contacting the fluorinated support with the transition metal ligand via the methods described herein unexpectedly results in a supported catalyst composition that is active without alkylation processes (e.g., contact of the catalyst component with an organometallic compound, such as MAO.)

The absence of substances, such as MAO, generally results in lower polymer production costs as alumoxanes are expensive compounds. Further, alumoxanes are generally unstable compounds that may require cold storage. However, embodiments of the present invention unexpectedly result in a catalyst composition that may be stored at room temperature for periods of time (e.g., up to 2 months) and then used directly in polymerization reactions. Such storage stability further results in improved catalyst variability as a large batch of support material may be prepared and contacted with a variety of transition metal compounds (which may be formed in small amounts optimized based on the polymer to be formed.)

In addition, it is contemplated that polymerizations absent alumoxane activators result in minimal leaching/fouling in comparison with alumoxane based systems. However, embodiments of the invention generally provide processes wherein alumoxanes may be included without detriment.

In one or more embodiments, the fluorinated support and/or the transition metal compound may be contacted with at least one compound prior to or after contact with one another. The at least one compound is generally represented by the formula XRₙ, wherein X is selected from Group 12 to 13 metals, lanthanide series metals or combinations thereof and each R is independently selected from alkyls, alkoxys, aryls, aryloxys, halogens, hydrides, Group 1 or 2 metals, organic nitrogen compounds, organic phosphorous compounds and combinations thereof and n is from 2 to 5.

In one embodiment, the fluorinated support is contacted with the compound prior to contact with the transition metal compound. Alternatively, the fluorinated support may be contacted with the transition metal compound in the presence of the compound.

For example, the contact may occur by contacting the fluorinated support with the compound at a reaction temperature of from about 0° C. to about 150° C. or from about 20° C. to about 100° C. for a time of from about 10 minutes hour to about 5 hours or from about 30 minutes to about 120 minutes, for example.

In one embodiment, X includes aluminum. For example, the compound may include an organic aluminum compound. The organic aluminum compound may include triethyl aluminum (TEAl), triisobutyl aluminum (TIBAl), tri-n-hexyl aluminum (TNHAl), tri-n-octyl aluminum (TNOAl) or tri-isoprenyl aluminum (TISPAl), for example. However, in one specific embodiment, the supported catalyst system is formed in the absence of TIBAl.

In one embodiment, X includes boron. For example, the compound may include an organic boron compound, such as a C₂ to C₃₀ trialkyl boron. In one specific embodiment, the compound includes a borate. For example, the borate may include a borate salt, such as a lithium borate.

In one embodiment, the weight ratio of the silica to the compound (Si:X²) may be from about 0.01:1 to about 10:1 or from about 0.1:1 to about 7:1, for example. The compound generally contacts the fluorinated support (or components thereof) in an amount that is insufficient to alkylate the fluorinated support.

In one or more embodiments, the compound includes a plurality of compounds. For example, the plurality of compounds may include a first compound including aluminum and a second compound including borane. For example, the plurality of compounds may include a trialkyl aluminum and a trialkyl borane.

In one specific embodiment, the compound includes more aluminum than boron. For example, the compound may include only a minor amount of boron (e.g., less than about 10 wt. %, or less than about 5 wt. %, or less than about 2.5 wt. % or less than about 1.0 wt. %).

It is contemplated that the first and second compound may contact one another prior to, during or after contact with any portion of the fluorinated support.

While it has been observed that contacting the fluorinated support with the compound results in a catalyst having increased activity, it is contemplated that the compound may contact the transition metal compound. When the compound contacts the transition metal compound, the weight ratio of the compound to transition metal (X²:M) may be from about 0.1: to about 5000:1, for example.

Optionally, the fluorinated support may be contacted with one or more scavenging compounds and/or anti-fouling agents prior to or during polymerization. The term “scavenging compounds” is meant to include those compounds effective for removing impurities (e.g., polar impurities) from the subsequent polymerization reaction environment. Impurities may be inadvertently introduced with any of the polymerization reaction components, particularly with solvent, monomer and catalyst feed, and adversely affect catalyst activity and stability. Such impurities may result in decreasing, or even elimination, of catalytic activity, for example. The polar impurities or catalyst poisons may include water, oxygen and metal impurities, for example.

The scavenging compound may include an excess of the first or second aluminum compounds described above, or may be additional known organometallic compounds, such as Group 13 organometallic compounds. For example, the scavenging compounds may include triethyl aluminum (TMA), triisobutyl aluminum (TIBAl), methylalumoxane (MAO), isobutyl aluminoxane and tri-n-octyl aluminum. In one specific embodiment, the scavenging compound is TIBAl.

In one embodiment, the amount of scavenging compound is minimized during polymerization to that amount effective to enhance activity and avoided altogether if the feeds and polymerization medium may be sufficiently free of impurities.

Polymerization Processes

As indicated elsewhere herein, catalyst systems are used to form polyolefin compositions. Once the catalyst system is prepared, as described above and/or as known to one skilled in the art, a variety of processes may be carried out using that composition. The equipment, process conditions, reactants, additives and other materials used in polymerization processes will vary in a given process, depending on the desired composition and properties of the polymer being formed. Such processes may include solution phase, gas phase, slurry phase, bulk phase, high pressure processes or combinations thereof, for example. (See, U.S. Pat. No. 5,525,678, U.S. Pat. No. 6,420,580, U.S. Pat. No. 6,380,328, U.S. Pat. No. 6,359,072, U.S. Pat. No. 6,346,586, U.S. Pat. No. 6,340,730, U.S. Pat. No. 6,339,134, U.S. Pat. No. 6,300,436, U.S. Pat. No. 6,274,684, U.S. Pat. No. 6,271,323, U.S. Pat. No. 6,248,845, U.S. Pat. No. 6,245,868, U.S. Pat. No. 6,245,705, U.S. Pat. No. 6,242,545, U.S. Pat. No. 6,211,105, U.S. Pat. No. 6,207,606, U.S. Pat. No. 6,180,735 and U.S. Pat. No. 6,147,173, which are incorporated by reference herein.)

In certain embodiments, the processes described above generally include polymerizing olefin monomers to form polymers. The olefin monomers may include C₂ to C₃₀ olefin monomers, or C₂ to C₁₂ olefin monomers (e.g., ethylene, propylene, butene, pentene, methylpentene, hexene, octene and decene), for example. Other monomers include ethylenically unsaturated monomers, C₄ to C₁₈ diolefins, conjugated or nonconjugated dienes, polyenes, vinyl monomers and cyclic olefins, for example. Non-limiting examples of other monomers may include norbornene, nobornadiene, isobutylene, isoprene, vinylbenzocyclobutane, sytrene, alkyl substituted styrene, ethylidene norbornene, dicyclopentadiene and cyclopentene, for example. The formed polymer may include homopolymers, copolymers or terpolymers, for example.

Examples of solution processes are described in U.S. Pat. No. 4,271,060, U.S. Pat. No. 5,001,205, U.S. Pat. No. 5,236,998 and U.S. Pat. No. 5,589,555, which are incorporated by reference herein.

One example of a gas phase polymerization process includes a continuous cycle system, wherein a cycling gas stream (otherwise known as a recycle stream or fluidizing medium) is heated in a reactor by heat of polymerization. The heat is removed from the cycling gas stream in another part of the cycle by a cooling system external to the reactor. The cycling gas stream containing one or more monomers may be continuously cycled through a fluidized bed in the presence of a catalyst under reactive conditions. The cycling gas stream is generally withdrawn from the fluidized bed and recycled back into the reactor. Simultaneously, polymer product may be withdrawn from the reactor and fresh monomer may be added to replace the polymerized monomer. The reactor pressure in a gas phase process may vary from about 100 psig to about 500 psig, or from about 200 psig to about 400 psig or from about 250 psig to about 350 psig, for example. The reactor temperature in a gas phase process may vary from about 30° C. to about 120° C., or from about 60° C. to about 115° C., or from about 70° C. to about 110° C. or from about 70° C. to about 95° C., for example. (See, for example, U.S. Pat. No. 4,543,399, U.S. Pat. No. 4,588,790, U.S. Pat. No. 5,028,670, U.S. Pat. No. 5,317,036, U.S. Pat. No. 5,352,749, U.S. Pat. No. 5,405,922, U.S. Pat. No. 5,436,304, U.S. Pat. No. 5,456,471, U.S. Pat. No. 5,462,999, U.S. Pat. No. 5,616,661, U.S. Pat. No. 5,627,242, U.S. Pat. No. 5,665,818, U.S. Pat. No. 5,677,375 and U.S. Pat. No. 5,668,228, which are incorporated by reference herein.) In one embodiment, the polymerization process is a gas phase process and the transition metal compound used to form the supported catalyst composition is CpFlu.

Slurry phase processes generally include forming a suspension of solid, particulate polymer in a liquid polymerization medium, to which monomers and optionally hydrogen, along with catalyst, are added. The suspension (which may include diluents) may be intermittently or continuously removed from the reactor where the volatile components can be separated from the polymer and recycled, optionally after a distillation, to the reactor. The liquefied diluent employed in the polymerization medium may include a C₃ to C₇ alkane (e.g., hexane or isobutene), for example. The medium employed is generally liquid under the conditions of polymerization and relatively inert. A bulk phase process is similar to that of a slurry process. However, a process may be a bulk process, a slurry process or a bulk slurry process, for example.

In a specific embodiment, a slurry process or a bulk process may be carried out continuously in one or more loop reactors. The catalyst, as slurry or as a dry free flowing powder, may be injected regularly to the reactor loop, which can itself be filled with circulating slurry of growing polymer particles in a diluent, for example. Optionally, hydrogen may be added to the process, such as for molecular weight control of the resultant polymer. The loop reactor may be maintained at a pressure of from about 27 bar to about 45 bar and a temperature of from about 38° C. to about 121° C., for example. Reaction heat may be removed through the loop wall via any method known to one skilled in the art, such as via a double-jacketed pipe.

Alternatively, other types of polymerization processes may be used, such stirred reactors in series, parallel or combinations thereof, for example. Upon removal from the reactor, the polymer may be passed to a polymer recovery system for further processing, such as addition of additives and/or extrusion, for example.

In one embodiment, the catalyst preparation is an in-situ process. Such process may occur with our without isolation of the fluorinated catalyst. While an increase in catalytic activity has been observed as a result of contacting the supported catalyst system (or components thereof) with the compound represented by the formula XR₃ regardless of isolation, processes utilizing non-isolated catalysts resulted in catalyst activities different than that obtained with isolated catalysts.

Polymer Product

The polymers (and blends thereof) formed via the processes described herein may include, but are not limited to, linear low density polyethylene, elastomers, plastomers, high density polyethylenes, low density polyethylenes, medium density polyethylenes, polypropylene (e.g., syndiotactic, atactic and isotactic) and polypropylene copolymers, for example.

In one embodiment, the polymer includes a bimodal molecular weight distribution. The bimodal molecular weight distribution polymer may be formed by a supported catalyst composition including a plurality of transition metal compounds.

In one or more embodiments, the polymer has a narrow molecular weight distribution (e.g., a molecular weight distribution of from about 2 to about 4.) In another embodiment, the polymer has a broad molecular weight distribution (e.g., a molecular weight distribution of from about 4 to about 25.)

Product Application

The polymers and blends thereof are useful in applications known to one skilled in the art, such as forming operations (e.g., film, sheet, pipe and fiber extrusion and co-extrusion as well as blow molding, injection molding and rotary molding). Films include blown or cast films formed by co-extrusion or by lamination useful as shrink film, cling film, stretch film, sealing films, oriented films, snack packaging, heavy duty bags, grocery sacks, baked and frozen food packaging, medical packaging, industrial liners, and membranes, for example, in food-contact and non-food contact application. Fibers include melt spinning, solution spinning and melt blown fiber operations for use in woven or non-woven form to make filters, diaper fabrics, medical garments and geotextiles, for example. Extruded articles include medical tubing, wire and cable coatings, geomembranes and pond liners, for example. Molded articles include single and multi-layered constructions in the form of bottles, tanks, large hollow articles, rigid food containers and toys, for example.

While the foregoing is directed to embodiments of the present invention, other and further embodiments of the invention may be devised without departing from the basic scope thereof and the scope thereof is determined by the claims that follow.

### EXAMPLES

In the following examples, samples of fluorinated metallocene catalyst compounds utilizing various Group 12 to 13 metal compounds were prepared.

As used below “alumina-silica support composition” refers to alumina-silica that was obtained from Grace Davison (13 wt. % Al).

Support Preparation Method A: The preparation of support material A was achieved by mixing 15.0 g of the alumina-silica support composition in 60 mL of water with 3.1 g of NH₄Fl₂ (dissolved in 25 mL of water) within a 250 mL round bottom flask to form a fluorided support including 20 wt. % fluorinating agent. The water was then removed under vacuum at 90° C. The resulting solids were then heated in a muffle furnace at 400° C. for 3 hours.

Support Preparation Method B: The preparation of support material B was achieved by mixing the alumina-silica support composition with Et₃B in hexane at ambient conditions to form a fluorided support, which was subsequently dried.

The dried support material was then contacted with (NH₄)₂SiF₆ to form a fluorided support including 20 wt. % fluorinating agent. The resulting solids were then heated under air in a tube furnace at 400° C. for 2 hours.

Catalyst Preparation Method A: The preparation of support material A was achieved by mixing 15.0 g of the alumina-silica support composition (15 wt. % of alumina) in 60 mL of water with 3.0 g of NH₄F.HF (dissolved in 25 mL of water) within a 250 mL round bottom flask to form a fluorided support including 20 wt. % fluorinating agent. The water was then removed under vacuum at 90° C. The resulting solids were then heated in a muffle furnace at 400° C. for 3 hours.

Support Preparation Method B: 3.0 grams of alumina-silica (13 wt. % of alumina) was placed in a 250, 1-neck, schlenk round bottom flask and placed in a glass-drying oven at 145° C. for 16 hours. The flask was capped with a rubber septum and placed under vacuum. After the flask cooled to ambient temperature, it was stored in a glove box under nitrogen.

15.0 grams of the dry alumina-silica was slurried in 30.0 mL of isohexane followed by adding 7.72 mL Et₃B (Aldrich, 1M in Hexane). After stirring at room temperature for about 1.5 hours, the slurry was filtered though a glass fritted filter funnel and washed 3× each with 30.0 mL of isohexane. The resulting solids were dried under vacuum at ambient temperature. The dry boron-treated AlSiO₂ was then dry mixed with 3.0 grams of (NH₄)₂SiF₆ and transferred into a glass quartz tube. The solids were then heated at 450° C. for 2 hours under 0.6 SLPM N₂ flow. After cooling to room temperature, the solids were collected and stored under nitrogen in a glove box.

The preparation of support material B was achieved by mixing the alumina-silica support composition with Et₃B in hexane at ambient conditions to form a fluorided support, which was subsequently dried.

Catalyst Preparation Method C: The preparation of Catalyst C was achieved by slurrying a support material in hexane. The slurry was then contacted with Et₃B (5 wt. %). The treated slurry was then filtered and washed with hexane.

The preparation further included contacting dimethylsilylbis(2-methyl-4-phenyl-1-indenyl)zirconium dichloride with AlR₃ (AlR₃/support weight ratio is 1) at ambient conditions. The resulting mixture was then added to the slurry to form a supported catalyst system including 1 wt. % metallocene. The supported catalyst system was then stirred for 1.0 hour.

Catalyst Preparation Method D: The preparation of Catalyst D was achieved by slurrying a support material (B) in hexane. The slurry was then contacted with TIBAl (TIBAl/support weight ratio is 0.5).

The preparation further included contacting dimethylsilylbis(2-methyl-4-phenyl-1-indenyl)zirconium dichloride with AlR₃ (AlR₃/support weight ratio is 0.5) at ambient conditions. The resulting mixture was then added to the slurry to form a supported catalyst system including 1 wt. % metallocene. The supported catalyst system was then stirred for 30 minutes.

Catalyst Preparation Method E: The preparation of Catalyst E was achieved by slurrying a support material in hexane. The slurry was then contacted with AlR₃. (AlR₃/support weight ratio is 0.5).

The preparation further included contacting dimethylsilylbis(2-methyl-4-phenyl-1-idenyl)zirconium dichloride with AlR₃ at ambient conditions. The resulting mixture was then added to the slurry form a supported catalyst system including 1 wt. % metallocene. The supported catalyst system was then stirred for 30 minutes.

Polymerizations: The resulting catalysts were then contacted with propylene monomer to form polypropylene. The polymerizations were conducted in a 6-x pack (6×500 ml) parallel bench reactor and in 2L Zipperclave bench reactor. The results of such polymerizations follow in Tables 1 and 2, respectively.

TABLE 1

| | | | | Cat | H₂ | Time | Activity |
|---|---|---|---|---|---|---|---|
| Run | Support | Catalyst | R | (mg) | (ppm) | (min) | (g/g/h) |
| 1 | A | A¹ | N/A | 15 | 78 | 30 | 2317 |
| 2 | A | E¹ | i-Bu | 15 | 78 | 30 | 11873 |
| 3 | A | E² | i-Bu | 30 | 42 | 30 | 10777 |
| 4 | A | E² | i-Bu | 30 | 42 | 30 | 11248 |
| 5 | A | B¹ | i-Bu | 15 | 78 | 30 | 6373 |
| 6 | A | C² | i-Bu | 30 | 42 | 30 | 11466 |
| 7 | B | D² | i-Bu | 30 | 42 | 30 | 11344 |
| 8 | A | E¹ | n-Oct | 15 | 78 | 30 | 13804 |
| 9 | A | E¹ | n-Oct | 15 | 78 | 30 | 15203 |
| 10 | A | E¹ | n-Oct | 15 | 78 | 60 | 9178 |
| 11 | A | E¹ | n-Oct | 15 | 156 | 30 | 12626 |
| 12 | A | B¹ | n-Oct | 15 | 78 | 30 | 12875 |
| 13 | A | B¹ | n-Oct | 10 | 78 | 30 | 13890 |
| 14 | A | B¹ | n-Oct | 10 | 78 | 60 | 10710 |
| 15 | A | B¹ | n-Oct | 10 | 156 | 30 | 18193 |
| 16 | A | E¹ | n-Hex | 15 | 78 | 30 | 12457 |
| 17 | A | E¹ | i-prenyl | 15 | 78 | 30 | 13 |

¹= 500 ml reactor, 180 g PP,
²= 2 L reactor, 700 g PP, all at 67° C.

Acceptable catalyst activities were observed with tri-n-hexyl aluminum (TNHAl), tri-n-octyl aluminum (TNOAl), and tri-iso-butyl aluminum (TIBAl). However, in contrast to isolation methods (wherein TIBAl generally exhibits higher activities than TNOAl), TNOAl demonstrated the highest catalyst activity with in-situ catalyst preparation methods.

However, it has been discovered that when triethyl borane (Et₃B) is present during the catylyst preparartion, the activity of the TIBAl system decreased, while the TNOAl system demonstrated about the same or increased catalytic activity.

TABLE 2

| | MFI | | | | | | | | |
|---|---|---|---|---|---|---|---|---|---|
| | (g/10 | | | | | | | | |
| Run | min.) | XS (%) | Tᵣ(° C.) | ΔHᵣ(J/g) | Tₘ(° C.) | ΔHₘ(J/g) | Mw | Mw/Mn | Mz/Mw |
| 1 | 19.4 | 0.28 | 110.1 | 95.7 | 150.8 | 95.5 | 193507 | 4.0 | 2.0 |
| 2 | 1.4 | ND | 107.9 | 92.2 | 150.1 | 90.2 | 627243 | 6.4 | 2.5 |
| 3 | 6.0 | ND | 109.4 | 91.3 | 150.7 | 107.8 | 321580 | 7.9 | 2.8 |
| 4 | 5.6 | ND | 109.4 | 98.6 | 150.5 | 97.2 | 393365 | 7.6 | 3.1 |
| 5 | 19.8 | ND | 106.6 | 92.7 | 1506 | 91.5 | 225149 | 4.2 | 2.1 |
| 6 | 9.7 | NR | 108.4 | 88.1 | 151.0 | 100.4 | 282459 | 5.5 | 2.4 |
| 7 | 3.0 | NR | 107.8 | 94.9 | 150.6 | 104.1 | 370879 | 5.8 | 2.4 |
| 8 | <1 | NR | 105.7 | 89.1 | 149.9 | 102.3 | 567369 | 3.9 | 2.2 |
| 9 | 7.6 | <0.2 | 106.0 | 64.7 | 150.5 | 95.6 | 332279 | 5.1 | 2.3 |
| 10 | 3.4 | <0.2 | 106.7 | 93.6 | 150.1 | 93.4 | 409637 | 6.4 | 2.4 |
| 11 | 62.2 | 0.20 | 110.2 | 97.7 | 150.3 | 100.6 | 137059 | 5.1 | 2.1 |
| 12 | 1.1 | <0.2 | 106.8 | 90.5 | 150.4 | 100.8 | NR | NR | NR |
| 13 | 5.7 | <0.2 | 108.3 | 95.5 | 150.5 | 96.0 | 395923 | 4.6 | 2.3 |
| 14 | <1 | ND | 105.6 | 96.1 | 149.9 | 97.7 | 484894 | 5.9 | 2.3 |
| 15 | 6.8 | ND | 109.2 | 96.5 | 150.9 | 95.8 | 315293 | 6.8 | 2.9 |
| 16 | 1.0 | NR | 106.6 | 95.8 | 149.6 | 108.4 | 536058 | 4.3 | 2.3 |
| 17 | NR | NR | NR | NR | NR | NR | NR | NR | NR |

Tᵣ is recrystallization temperature, Tₘ is the peak melt temperature

While the polymers produces showed consistent Tm and Hr regardless of the polymerization conditions or type of reactor, the melt flow and Mw varied depending on the type of reactor system. Further, the melt flow of the polymers increased with an increase of hydrogen.

What is claimed is:

1. A method of forming a catalyst composition for olefin polymerization:
providing an inorganic support composition, wherein the inorganic support composition comprises aluminum, fluorine and silica;
contacting the inorganic support composition with a transition metal compound to form a supported catalyst system, wherein the transition metal compound is represented by the formula [L]ₘM[A]ₙ; wherein L is a bulky ligand, A is a leaving group, M is a transition metal and m and n are such that a total ligand valency corresponds to the transition metal valency; and
contacting the inorganic support composition, the transition metal compound, the supported catalyst system or combinations thereof with at least one compound represented by the formula XRₙ, wherein X is selected from Group 12 to 13 metals, lanthanide series metals or combinations thereof and each R is independently selected from alkyls, alkoxys, aryls, aryloxys, halogens, hydrides, Group 1 or 2 metals, organic nitrogen compounds, organic phosphorous compounds and combinations thereof and n is from 2 to 5.

2. The method of claim 1, wherein each R is selected from C₄ to C₃₀ alkyls.

3. The method of claim 1, wherein each R is selected from C₄ to C₈ alkyls.

4. The method of claim 1, wherein X comprises aluminum.

5. The method of claim 1, wherein X comprises boron.

6. The method of claim 1, wherein the at least one compound comprises a plurality of compounds.

7. The method of claim 6, wherein the at least one compound comprises a trialkyl aluminum and a trialkyl boron.

8. The method of claim 1, wherein the inorganic support composition comprises a bonding sequence selected from Si—O—Al—F, F—Si—O—Al, F—Si—O—Al—F and combinations thereof.

9. The method of claim 1, wherein the aluminum and fluorine of the inorganic support composition are chemically bonded.
support composition are chemically bonded.

10. The method of claim 1, wherein the inorganic support composition comprises from about 1 to about 70 wt. % fluorine.

11. The method of claim 1, wherein the inorganic support composition comprises from about 1 to about 30 wt. % fluorine.

12. The method of claim 1, wherein the inorganic support composition comprises from about 2 to about 15 wt. % fluorine.

13. The method of claim 1, wherein the inorganic support composition comprises from about 2 to about 10 wt. % fluorine.

14. The method of claim 1, wherein the inorganic support composition comprises from about 5 to about 7 wt. % fluorine.

15. The method of claim 1, wherein the inorganic support composition comprises from about 1 to about 60 wt. % aluminum.

16. The method of claim 1, wherein the inorganic support composition comprises from about 2 to about 25 wt. % aluminum.

17. The method of claim 1, wherein the inorganic support composition comprises from about 10 to about 20 wt. % aluminum.

18. The method of claim 1, wherein the inorganic support composition comprises from about 13 to about 17 wt. % aluminum.

19. A supported catalyst composition formed by the method of claim 1.

20. The method of claim 1, wherein the L comprises a C₄ to C₃₀ hydrocarbon, oxygen, nitrogen, phosphorus or combinations thereof, M is selected from Group 3 to 14 metals, lanthanides, actinides and combinations thereof and A is selected from halogens and C₄ to C₃₀ hydrocarbons.

21. The method of claim 1, wherein the transition metal compound comprises a Cp-Flu metallocene.

22. The method of claim 1, wherein the transition metal compound comprises a Bis-indenyl metallocene.

23. The method of claim 1, wherein the transition metal compound comprises a Bis-indenyl metallocene and a Cp-Flu metallocene.

24. The method of claim 1, wherein the transition metal compound comprises dimethylsilylbis(2-methyl-4-phenyl-indenyl)zirconium dichloride.

25. The method of claim 1, wherein the supported catalyst composition is active for polymerization absent alkylation.

26. The method of claim 1, wherein the at least one compound contacts the transition metal compound in an amount that is insufficient to alkylate the transition metal compound.

27. The method of claim 1 further comprising contacting the supported catalyst system with an olefin monomer to form a polyolefin, wherein the polyolefin comprises a polymer selected from ethylene, a C₃ or greater alpha olefin, a C₄ or greater conjugated diene, an ethylene-alpha olefin copolymer or combinations thereof.

28. The method of claim 1 further comprising contacting the supported catalyst system with an olefin monomer to form a polyolefin, wherein the polyolefin is selected from polyethylene, polypropylene, alpha olefins represented by the formula CH₂═CHR, wherein R is a C₂ to C₂₀ alkyl radical, C₆ to C₃₀ styrenic olefins and combinations thereof.

29. The method of claim 1, wherein the polyolefin is formed in an in-situ process.

30. The method of claim 1, further comprising isolating the supported catalyst system.

31. The method of claim 1, wherein the supported catalyst system contacts the olefin monomer without isolation.

32. The method of claim 1 further comprising contacting the inorganic support composition, the transition metal compound or the supported catalyst system with an anti-fouling agent.

33. The method of claim 1, at least one compound is represented by the formula XR₃, wherein X is selected from Group 12 to 13 metals, lanthanide series metals or combinations thereof and each R is independently selected from alkyls, alkoxys, aryls, aryloxys, halogens, hydrides and combinations thereof.

34. A method of forming a catalyst composition for olefin polymerization:
providing an inorganic support composition, wherein the inorganic support composition comprises aluminum, fluorine and silica;
contacting the inorganic support composition with a transition metal compound to form a supported catalyst system, wherein the transition metal compound is represented by the formula [L]ₘM[A]ₙ; wherein L is a bulky ligand, A is a leaving group, M is a transition metal and m and n are such that a total ligand valency corresponds to the transition metal valency; and
contacting the inorganic support composition, the transition metal compound, the supported catalyst system or combinations thereof with a plurality of compounds, wherein the plurality of compounds comprise a first compound comprising an organo aluminum compound and a second compound comprising boron.

35. A polymerization process comprising:
providing an inorganic support composition, wherein the inorganic support composition comprises aluminum, fluorine and silica;
contacting the inorganic support composition with a transition metal compound to form a supported catalyst system, wherein the transition metal compound is represented by the formula [L]ₘM[A]ₙ; wherein L is a bulky ligand, A is a leaving group, M is a transition metal and m and n are such that a total ligand valency corresponds to the transition metal valency;
contacting the inorganic support composition, the transition metal compound, the supported catalyst system or combinations thereof with at least one compound represented by the formula XRₙ, wherein X is selected from Group 12 to 13 metals, lanthanide series metals or combinations thereof and each R is independently selected from alkyls, alkoxys, aryls, aryloxys, halogens, hydrides, Group 1 or 2 metals, organic nitrogen compounds, organic phosphorous compounds and combinations thereof and n is from 2 to 5; and
contacting the supported catalyst system with an olefin monomer to form a polyolefin.
